(19) United States
(12) Patent Application Publication
(10) Pub. No.: US 2019/0082449 A1
(43) Pub. Date: Mar. 14, 2019

(54) USER EQUIPMENTS, BASE STATIONS AND METHODS FOR DUAL CONNECTIVITY

(71) Applicant: Sharp Laboratories of America, Inc., Camas, WA (US)

(72) Inventors: Kyung Ho Kim, San Jose, CA (US); Toshizo Nogami, Chiba (JP); Jia Sheng, Vancouver, WA (US)

(21) Appl. No.: 16/124,498

(22) Filed: Sep. 7, 2018

Related U.S. Application Data
(63) Continuation of application No. PCT/US2018/049679, filed on Sep. 6, 2018.
(60) Provisional application No. 62/556,172, filed on Sep. 8, 2017.

(51) Int. Cl. H04W 72/12; H04W 72/04

(52) U.S. Cl. CPC H04W 72/1268; H04W 72/0473

(57) ABSTRACT

A user equipment (UE) is described. The UE is configured to transfer a dedicated radio resource control (RRC) configuration message including information indicating a minimum required window size for look-ahead (LA) processing. The UE is configured to transfer information indicating an uplink (UL) quality report. The UE is configured to acquire information indicating an LA enable signal, an LA window, and an UL quality threshold. The UE is configured to transmit the PUSCH in a first cell group upon detection of the PDCCH. If the PUSCH is transmitted within the LA window, a first transmit power of the PUSCH is derived using a second transmit power of a physical uplink channel of a second cell group. If the PUSCH is transmitted outside the LA window, the first transmit power of the PUSCH is derived without using the second transmit power of the physical uplink channel of the second cell group.

### RELATED APPLICATIONS

This application is related to and claims priority from U.S. Provisional Patent Application No. 62/556,172, entitled “USER EQUIPMENTS, BASE STATIONS AND METHODS FOR DUAL CONNECTIVITY,” filed on Sep. 8, 2017, which is hereby incorporated by reference herein, in its entirety.

### TECHNICAL FIELD

The present disclosure relates generally to communication systems. More specifically, the present disclosure relates to new signaling, procedures, user equipment (UE) and base stations for dual connectivity.

### BACKGROUND

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### BRIEF DESCRIPTION OF THE DRAWINGS

FIG. 1 is a block diagram illustrating one implementation of one or more next generation Node Bs (gNBs) and one or more user equipments (UEs) in which systems and methods for dual connectivity may be implemented;

FIG. 2 is a diagram illustrating one example of a resource grid;

FIG. 3 shows examples of downlink (DL) control channel monitoring regions;

FIG. 4 shows examples of DL control channel which consists of more than one control channel elements;

FIG. 5 is a diagram illustrating examples of power control modes (PCMs) that may be implemented in accordance with some examples of the systems and methods disclosed herein;

FIG. 6 is a diagram illustrating examples of a timing condition for application of look-ahead (LA) in accordance with some examples of the systems and methods disclosed herein;

FIG. 7 is a flow diagram illustrating one example of a method for dual connectivity;

FIG. 8 is a flow diagram illustrating one example of a method for dual connectivity;

FIG. 9 illustrates various components that may be utilized in a UE;

FIG. 10 illustrates various components that may be utilized in a gNB;

FIG. 11 is a block diagram illustrating one implementation of a UE in which systems and methods for performing uplink transmissions may be implemented;

FIG. 12 is a block diagram illustrating one implementation of a gNB in which systems and methods for performing uplink transmissions may be implemented;

FIG. 13 shows examples of several numerologies;

FIG. 14 shows a set of examples of subframe structures for the numerologies that are shown in FIG. 13;

FIG. 15 shows another set of examples of subframe structures for the numerologies that are shown in FIG. 13;

FIG. 16 shows examples of slots and sub-slots;

FIG. 17 shows examples of scheduling timelines;

FIG. 18 is a block diagram illustrating one implementation of a gNB; and

FIG. 19 is a block diagram illustrating one implementation of a UE.

### DETAILED DESCRIPTION

A user equipment (UE) is described. The UE includes a higher layer processor configured to transfer a dedicated radio resource control (RRC) configuration message as part of UE capability information. The dedicated RRC configuration message includes information indicating a minimum required window size for look-ahead (LA) processing. The UE includes a higher layer processor configured to transfer a dedicated RRC configuration message. The dedicated RRC configuration message includes information indicating an uplink (UL) quality report. The UE includes a higher layer processor configured to acquire a dedicated RRC configuration message. The dedicated RRC configuration message includes information indicating an LA enable signal, an LA window, and an UL quality threshold. The UE includes physical downlink control channel (PDCCH) receiving circuitry configured to monitor a PDCCH. The PDCCH carries a downlink control information (DCI) format that schedules a physical uplink shared channel (PUSCH). The UE includes PUSCH transmitting circuitry configured to transmit the PUSCH in a first cell group upon detection of the PDCCH. In a case the PUSCH is transmitted within the LA window, a first transmit power of the PUSCH is derived using a second transmit power of a physical uplink channel of a second cell group. In a case the PUSCH is transmitted outside the LA window, the first transmit power of the PUSCH is derived without using the second transmit power of the physical uplink channel of the second cell group. A transmission of the physical uplink channel starts after a transmission of the PUSCH starts.

A base station apparatus is described. The base station apparatus includes a higher layer processor configured to transmit a dedicated radio resource control (RRC) configuration message. The dedicated RRC configuration message includes information indicating a look-ahead (LA) enable signal, an LA window, and an uplink (UL) quality threshold. The base station apparatus includes physical downlink control channel (PDCCH) transmitting circuitry configured to transmit a PDCCH. The PDCCH carries a downlink control information (DCI) format that schedules a physical uplink shared channel (PUSCH). The base station apparatus includes PUSCH receiving circuitry configured to receive the PUSCH in a first cell group upon detection of the PDCCH. In a case the PUSCH is transmitted within the LA window, a first transmit power of the PUSCH is derived using a second transmit power of a physical uplink channel of a second cell group. In a case the PUSCH is transmitted outside the LA window, the first transmit power of the PUSCH is derived without using the second transmit power of the physical uplink channel of the second cell group. A transmission of the physical uplink channel starts after a transmission of the PUSCH starts.

A method performed by a user equipment (UE) is described. The method includes transferring a dedicated radio resource control (RRC) configuration message as part of UE capability information. The dedicated RRC configuration message includes information indicating a minimum required window size for look-ahead (LA) processing. The method includes transferring a dedicated RRC configuration message. The dedicated RRC configuration message includes information indicating an uplink (UL) quality report. The method includes acquiring a dedicated RRC configuration message. The dedicated RRC configuration message includes information indicating an LA enable signal, an LA window, and an UL quality threshold. The method includes monitoring a PDCCH. The PDCCH carries a downlink control information (DCI) format that schedules a physical uplink shared channel (PUSCH). The method includes transmitting the PUSCH in a first cell group upon detection of the PDCCH. In a case the PUSCH is transmitted within the LA window, a first transmit power of the PUSCH is derived using a second transmit power of a physical uplink channel of a second cell group. In a case the PUSCH is transmitted outside the LA window, the first transmit power of the PUSCH is derived without using the second transmit power of the physical uplink channel of the second cell group. A transmission of the physical uplink channel starts after a transmission of the PUSCH starts.

A method performed by a base station apparatus is described. The method includes transmitting a dedicated radio resource control (RRC) configuration message. The dedicated RRC configuration message includes information indicating a look-ahead (LA) enable signal, an LA window, and an uplink (UL) quality threshold. The method includes transmitting a PDCCH. The PDCCH carries a downlink control information (DCI) format that schedules a physical uplink shared channel (PUSCH). The method includes receiving the PUSCH in a first cell group upon detection of the PDCCH. In a case the PUSCH is transmitted within the LA window, a first transmit power of the PUSCH is derived using a second transmit power of a physical uplink channel of a second cell group. In a case the PUSCH is transmitted outside the LA window, the first transmit power of the PUSCH is derived without using the second transmit power of the physical uplink channel of the second cell group. A transmission of the physical uplink channel starts after a transmission of the PUSCH starts.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A) and other standards (e.g., 3GPP Releases 8, 9, 10, 11, 12, 13, 14 and/or 15) including New Radio (NR) which is also known as 5G. However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a next generation Node B (gNB) or some other similar terminology. As the scope of the disclosure should not be limited to 3GPP standards, the terms “base station,” “Node B,” “eNB,” “HeNB” and “gNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An eNB and/or gNB may also be more generally referred to as a base station device.

It should be noted that as used herein, a “cell” may be any communication channel that is specified by standardization or regulatory bodies to be used for International Mobile Telecommunications-Advanced (IMT-Advanced) and all of it or a subset of it may be adopted by 3GPP as licensed bands (e.g., frequency bands) to be used for communication between an eNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

“Configured cells” are those cells of which the UE is aware and is allowed by an eNB to transmit or receive information. “Configured cell(s)” may be serving cell(s). The UE may receive system information and perform the required measurements on all configured cells. “Configured cell(s)” for a radio connection may include a primary cell and/or no, one, or more secondary cell(s). “Activated cells” are those configured cells on which the UE is transmitting and receiving. That is, activated cells are those cells for which the UE monitors the physical downlink control channel (PDCCH) and in the case of a downlink transmission, those cells for which the UE decodes a physical downlink shared channel (PDSCH). “Deactivated cells” are those configured cells that the UE is not monitoring the transmission PDCCH. It should be noted that a “cell” may be described in terms of differing dimensions. For example, a “cell” may have temporal, spatial (e.g., geographical) and frequency characteristics.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra-Reliable and Low Latency Communication) transmission, and eMTC (massive Machine Type Communication) transmission. Also, in NR, single-beam and/or multi-beam operations are considered for downlink and/or uplink transmissions.

In a previous 3GPP specification, a UE with LTE dual connectivity is semi-statically assigned a maximum guaranteed power (MGP) to guarantee a certain coverage for each cell group (i.e., master cell group (MCG) and secondary cell group (SCG)), leaving only the small portion of the remaining power to be utilized dynamically by the UE. This limits the usage of the full transmission power of a UE, since, even if the UE needs to increase the transmission power of one UL transmission beyond the MGP, the MGP for the other UL transmission always has to be remain unavailable even when there may be no UL transmission in that connection. Solely depending on the semi-static configuration may not provide timely provision to provide full efficiency of the usage of full power available for the UE. This may result because the channel condition and the scheduling of a different type of service or traffic may change faster (especially when downlink/uplink (DL/UL) short transmission time interval (sTTI)/reduced UE processing time based operation is configured for the UE, for instance). No specific solution exists currently.

Some implementations of the systems and methods disclosed herein may provide a dynamic configuration with look-ahead (LA) processing for a scheduler in a UE. This may effectively resolve the issue described above. For example, the scheduler may check the UE's own configurations including the semi-static configurations such as measurement gap, DRX, and DL/UL configuration on both connections, and may also schedule dynamic UL data during the LA duration. However, since LA processing requires additional computational processing on UE side, this may be enforced only when it is necessary. Accordingly, techniques to enforce the LA processing by higher layer signaling (or possibly with a media access control (MAC) control element (CE), and/or downlink control signaling), and the extension of the UE capability information to include a minimum window size for LA processing may be implemented in accordance with the systems and methods disclosed herein. Some examples may include UEs, base stations, and/or methods for LTE-NR dual connectivity.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

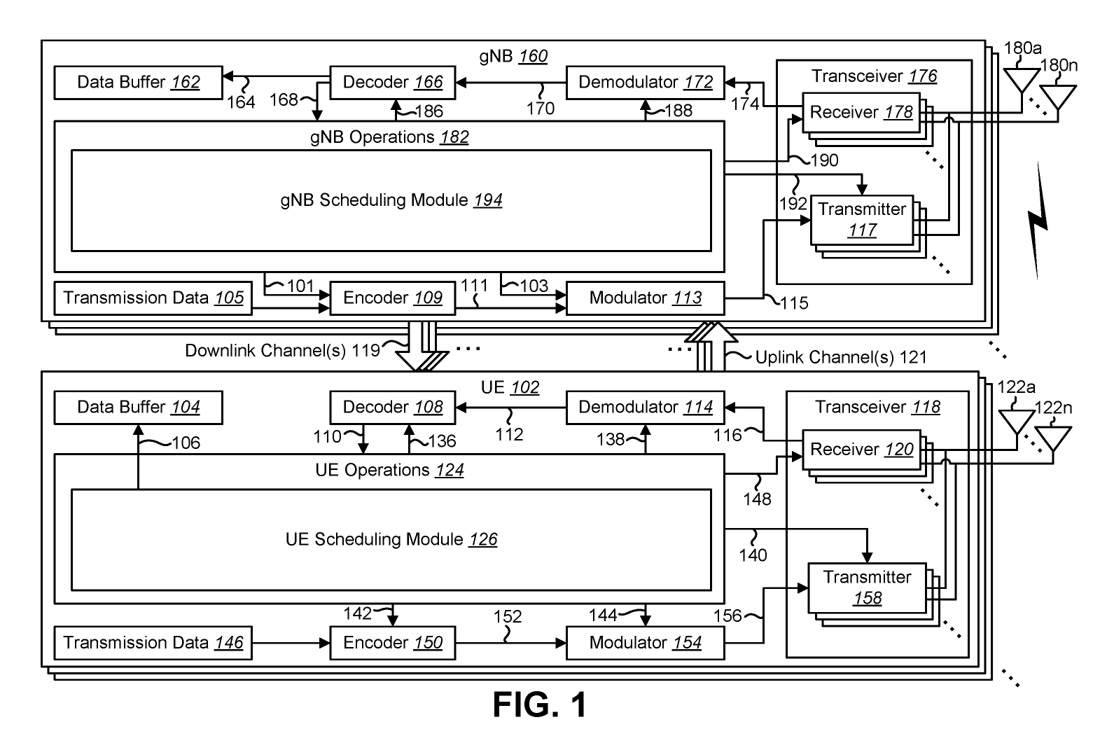

FIG. 1 is a block diagram illustrating one implementation of one or more gNBs 160 and one or more UEs 102 in which systems and methods for dual connectivity (e.g., LTE-NR dual connectivity) may be implemented. The one or more UEs 102 communicate with one or more gNBs 160 using one or more physical antennas 122a-n. For example, a UE 102 transmits electromagnetic signals to the gNB 160 and receives electromagnetic signals from the gNB 160 using the one or more physical antennas 122a-n. The gNB 160 communicates with the UE 102 using one or more physical antennas 180a-n.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (Physical Uplink Shared Channel)), and/or a physical control channel (e.g., PUCCH (Physical Uplink Control Channel)), etc. The one or more gNBs 160 may also transmit information or data to the one or more UEs 102 using one or more downlink channels 119, for instance. Examples of downlink channels 119 physical shared channel (e.g., PDSCH (Physical Downlink Shared Channel), and/or a physical control channel (PDCCH (Physical Downlink Control Channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include one or more of a UE scheduling module 126. The UE scheduling module 126 may perform one or more functions for dual connectivity.

In a radio communication system, physical channels (uplink physical channels and/or downlink physical channels) may be defined. The physical channels (uplink physical channels and/or downlink physical channels) may be used for transmitting information that is delivered from a higher layer. For example, PCCH (Physical Control Channel) may be defined. PCCH is used to transmit control information.

In uplink, PCCH (e.g., Physical Uplink Control Channel (PUCCH)) is used for transmitting Uplink Control Information (UCI). The UCI may include Hybrid Automatic Repeat Request (HARQ-ACK), Channel State information (CSI), and/or Scheduling Request (SR). The HARQ-ACK is used for indicating a positive acknowledgement (ACK) or a negative acknowledgment (NACK) for downlink data (e.g., Transport block(s), Medium Access Control Protocol Data Unit (MAC PDU), and/or Downlink Shared Channel (DL-SCH)). The CSI is used for indicating state of downlink channel. Also, the SR is used for requesting resources of uplink data (e.g., Transport block(s), MAC PDU, and/or Uplink Shared Channel (UL-SCH)).

In downlink, PCCH (e.g., Physical Downlink Control Channel (PDCCH)) may be used for transmitting Downlink Control Information (DCI). Here, more than one DCI formats may be defined for DCI transmission on the PDCCH. Namely, fields may be defined in the DCI format, and the fields are mapped to the information bits (e.g., DCI bits). For example, a DCI format 1A that is used for scheduling of one physical shared channel (PSCH) (e.g., PDSCH, transmission of one downlink transport block) in a cell is defined as the DCI format for the downlink.

Also, for example, a DCI format 0 that is used for scheduling of one PSCH (e.g., PUSCH, transmission of one uplink transport block) in a cell is defined as the DCI format for the uplink. For example, information associated with PSCH (a PDSCH resource, PUSCH resource) allocation, information associated with modulation and coding scheme (MCS) for PSCH, and DCI such as Transmission Power Control (TPC) command for PUSCH and/or PUCCH may be included the DCI format. Also, the DCI format may include information associated with a beam index and/or an antenna port. The beam index may indicate a beam used for downlink transmissions and uplink transmissions. The antenna port may include DL antenna port and/or UL antenna port.

Also, for example, PSCH may be defined. For example, in a case that the downlink PSCH resource (e.g., PDSCH resource) is scheduled by using the DCI format, the UE 102 may receive the downlink data, on the scheduled downlink PSCH resource. Also, in a case that the uplink PSCH resource (e.g., PUSCH resource) is scheduled by using the DCI format, the UE 102 transmits the uplink data, on the scheduled uplink PSCH resource. Namely, the downlink PSCH is used to transmit the downlink data. And, the uplink PSCH is used to transmit the uplink data.

Furthermore, the downlink PSCH and/or the uplink PSCH may be used to transmit information of a higher layer (e.g., Radio Resource Control (RRC)) layer, and/or MAC layer). For example, the downlink PSCH and the uplink PSCH may be used to transmit one or more RRC messages (e.g., RRC signals) and/or one or more MAC Control Elements (MAC CEs). Here, the RRC message that is transmitted from the gNB 160 in the downlink may be common to multiple UEs 102 within a cell (referred to as a common RRC message). Also, the RRC message that is transmitted from the gNB 160 may be dedicated to a certain UE 102 (referred to as a dedicated RRC message). The RRC message and/or the MAC CE may also be referred to as a higher layer signal.

Furthermore, in the radio communication for uplink, UL RS(s) may be used as uplink physical signal(s). The uplink physical signal may not be used to transmit information that is provided from the higher layer, but may be used by a physical layer. For example, the UL RS(s) may include the demodulation reference signal(s), the UE-specific reference signal(s), the sounding reference signal(s), and/or the beam-specific reference signal(s). The demodulation reference signal(s) may include demodulation reference signal(s) associated with transmission of uplink physical channel (e.g., PUSCH and/or PUCCH).

Also, the UE-specific reference signal(s) may include reference signal(s) associated with transmission of uplink physical channel (e.g., PUSCH and/or PUCCH). For example, the demodulation reference signal(s) and/or the UE-specific reference signal(s) may be a valid reference for demodulation of uplink physical channel only if the uplink physical channel transmission is associated with the corresponding antenna port. The gNB 160 may use the demodulation reference signal(s) and/or the UE-specific reference signal(s) to perform (re)configuration of the uplink physical channels. The sounding reference signal may be used to measure an uplink channel state.

In LTE-LTE dual connectivity, two power control modes may be defined, power control mode 1 (e.g., PCM 1 for synchronous UL connections) and power control mode 2 (e.g., PCM 2 for asynchronous uplink connections). If the UE 102 supports synchronous dual connectivity but does not support asynchronous dual connectivity, or if the UE 102 supports both synchronous dual connectivity and asynchronous dual connectivity and if the higher layer parameter powerControlMode indicates dual connectivity PCM 1, the UE 102 may use PCM 1 if the maximum uplink timing difference between transmitted signals to different serving cells including serving cells belonging to different cell groups (CGs) is equal to or less than the minimum requirement for maximum transmission timing difference for synchronous dual connectivity (e.g., 35.21 microseconds (μs)). The UE 102 may stop transmission on the Primary Secondary Cell (PSCell) if the UL transmission timing difference exceeds 35.21 μs. On the other hand, if the UE 102 supports both synchronous dual connectivity and asynchronous dual connectivity and if the higher layer parameter powerControlMode does not indicate dual connectivity PCM 1, the UE 102 may use PCM 2.

In PCM 1, a given uplink subframe (subframe i1) of the first cell group (CG) may basically overlap with one uplink subframe (subframe i2) of the second CG. To determine transmit powers of uplink physical channels/signals in subframe i1, transmit powers of uplink physical channels/signals in subframe i2 may be used, but physical channels/signals in the other subframes (e.g. subframe i2−1, subframe i2+1) may not be considered.

In PCM 2, a given subframe (subframe i1) of the first cell group (CG1) may basically overlap with two subframes (subframe i2−1 and subframe i2) of the second cell group (CG2). To determine transmit powers of physical channels/signals in subframe i1, transmit powers of physical channels/signals in subframe i2−1 may be used, but physical channels/signals in the other subframes (e.g., subframe i2−2, subframe i2, subframe i2+1) may not be considered, except for several cases. An exceptional case may be that the UE 102 has a PRACH transmission for CG2 overlapping with subframe i2 of CG2 and the transmission timing of the PRACH transmission is such that the UE 102 is ready to transmit the PRACH at least one subframe before subframe i2. In this instance, the transmit power for the PRACH in subframe i2 of CG2 may be used to determine transmit powers of physical channels/signals for CG1 in subframe i1.

LTE-NR dual connectivity may support at least semi-static power sharing (e.g., both a maximum guaranteed transmission power for LTE cell group and a maximum guaranteed transmission power for NR cell group that may be configured by higher-layer signaling). The above-described power control modes may also be applicable to LTE-NR dual connectivity. Additionally or alternatively, LTE-NR dual connectivity and/or NR-NR dual connectivity may use another power control scheme, for example, power control based on look-ahead (LA) processing. LA processing may be a procedure to take into account the future scheduling of the UL transmission on two (or more) connections to the NW (e.g., gNB 160, gNB scheduling module 194, etc.) and, as a result, to determine when an UL transmission may utilize the all available power allowed for the UE 102. The UE scheduling module 126 and/or the gNB scheduling module 194 may perform one or more aspects of power control (e.g., power control based on LA processing).

In some approaches, it may be assumed that subframe i1 (or slot i1) of CG1 (e.g., an NR cell group) overlaps subframe i2−1 and subframe i2 of CG2 (e.g., an LTE cell group). In this instance, the LA processing may be defined as one of the following.

To determine transmit powers of physical channels/signals in subframe i1, the UE 102 (e.g., UE scheduling module 126) may use transmit powers of physical channels/signals of CG2 that would be actually transmitted in subframe i2−1 and/or subframe i2 of CG2, irrespective of whether the physical channels/signals of CG2 are configured by higher layer signaling or scheduled by L1 signaling (e.g., PDCCH with a certain DCI format). The UE 102 (e.g., UE scheduling module 126) may not consider any physical channels/signals of CG2 which are not either scheduled or configured.

To determine transmit powers of physical channels/signals in subframe i1, the UE 102 (e.g., UE scheduling module 126) may use transmit powers of physical channels/signals of CG2 that are configured by higher-layer signaling to be transmitted in subframe i2−1 and/or subframe i2 of CG2. In addition, the UE 102 may consider transmit powers of physical channels/signals of CG2 that are scheduled to be transmitted in subframe i2 of CG2 if the transmission timing of the physical channels/signals is such that the UE 102 is ready to transmit the physical channels/signals with enough time before subframe i2 (e.g., at least X milliseconds (ms) before subframe i2). The UE 102 may not consider any physical channels/signals of CG2 that are not either scheduled or configured. Moreover, the UE 102 may not consider any physical channels/signals of CG2 which are scheduled Y (e.g., Y ms) before subframe i2, where Y<X. Here, X may be a fixed value. Alternatively, X may be given by and/or defined in UE 102 capability. Yet alternatively, X may be determined from a timing difference between a transmission of the target physical channel/signal of CG1 in subframe i1 and a reception of L1 signaling (e.g., a PDCCH with a certain DCI format) that schedules the target physical channel/signal.

To determine transmit powers of physical channels/signals in subframe i1, the UE 102 (e.g., UE scheduling module 126) may use transmit powers of physical channels/signals of CG2 which are configured by higher-layer signaling to be transmitted in subframe i2−1 and/or subframe i2 of CG2. In addition, the UE 102 (e.g., UE scheduling module 126) may consider transmit powers of physical channels/signals of CG2 in subframe i2−1 of CG2. The UE 102 may not consider any physical channels/signals of CG2 that are not either scheduled or configured. Moreover, the UE 102 may not consider any physical channels/signals of CG2 that are not configured by higher-layer signaling to be transmitted in subframe i2.

In LTE-NR dual connectivity, a UE 102 may inform the network (NW) (e.g., gNB 160), which the UE 102 connects to for dual connectivity, of the UE's capability of look-ahead (LA) processing when the UE 102 negotiates UE capability by providing a ‘minimum required window size’ for LA processing. After informing the NW, one or more of the following procedures may be performed in accordance with some implementations of the systems and methods disclosed herein.

In some cases and/or approaches, the NW (e.g., gNB 160, gNB scheduling module 194, etc.) may decide to enforce the LA processing for a specific UE 102 when the NW decides to enable LA processing by setting the parameter, LA_Enable, to TRUE. The NW (e.g., gNB 160, gNB scheduling module 194, etc.) may send this configuration parameter to the UE 102. When the UE 102 receives this parameter, which is set to TRUE, the UE 102 (e.g., US scheduling module 126) may start LA processing and may apply the result of the LA processing for adjusting its UL transmission power for a specific UL transmission. The LA processing may continue until the NW decides to stop the LA processing and sends an LA_Enable that is set to FALSE. One triggering criteria of enabling the LA processing may be an event where the UL quality becomes worse than a certain threshold (such as UL cyclic redundancy check (CRC) error count, for example) and the transmission power control (TPC) command to increase the UL transmission power does not work to improve the UL quality since the UL transmission power has already reached the maximum guaranteed power plus the remaining available power for that specific UL transmission. The NW (e.g., gNB 160, gNB scheduling module 194, etc.) may also send a time window, LA_Window, as a duration where LA processing should continue, together with LA_Enable set to TRUE. After this window expires, the UE 102 (e.g., UE scheduling module 126) may stop applying the LA processing. LA_Enable and LA_Window may both be configured by the sole discretion of the NW (e.g., gNB 160, gNB scheduling module 194, etc.).

In some cases and/or approaches, a UE 102 (e.g., UE scheduling module 126) itself may report to the NW (e.g., gNB 160, gNB scheduling module 194, etc.) on the UL quality or an indication of the UL quality so that the NW (e.g., gNB 160, gNB scheduling module 194, etc.) may decide to set the LA_Enable flag when the UL quality goes below a certain threshold set by the NW. Additionally or alternatively, the UE 102 may decide when to stop the LA processing when the LA_Window is not set and left empty. In this case, the UE 102 may decide to stop the LA processing based on the UE's 102 (e.g., UE scheduling module's 126) own decision based on the UL quality (in terms of whether the count of NAK'ed data becomes lower than a certain threshold provided by the NW (e.g., gNB 160, gNB scheduling module 194, etc.), for example). Another triggering criteria of sending the UL quality report to the NW (e.g., gNB 160, gNB scheduling module 194, etc.) may be that the TPC to increase the transmission power cannot be applied any further since it has already reached the maximum guaranteed power plus the remaining available power for that specific UL transmission.

When a UE 102 (e.g., UE scheduling module 126) applies the result of the LA processing to increase the UL transmission power of one UL connection, the UE 102 may use the whole maximum power allowed for that UE 102. For example, the UE 102 (e.g., UE scheduling module 126) may extend the UE's 102 transmission power into the MGP of the other UL transmission when there is no UL transmission on the other UL connection. It should be noted that each UE 102 may have a different ‘minimum required window size’ for LA processing since the LA processing itself depends on each UE 102's processing/computing capability.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first eNB-decoded signal 164 may comprise received payload data, which may be stored in a data buffer 162. A second eNB-decoded signal 168 may comprise overhead data and/or control data. For example, the second eNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB scheduling module 194. The gNB scheduling module 194 may perform one or more procedures as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to space, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

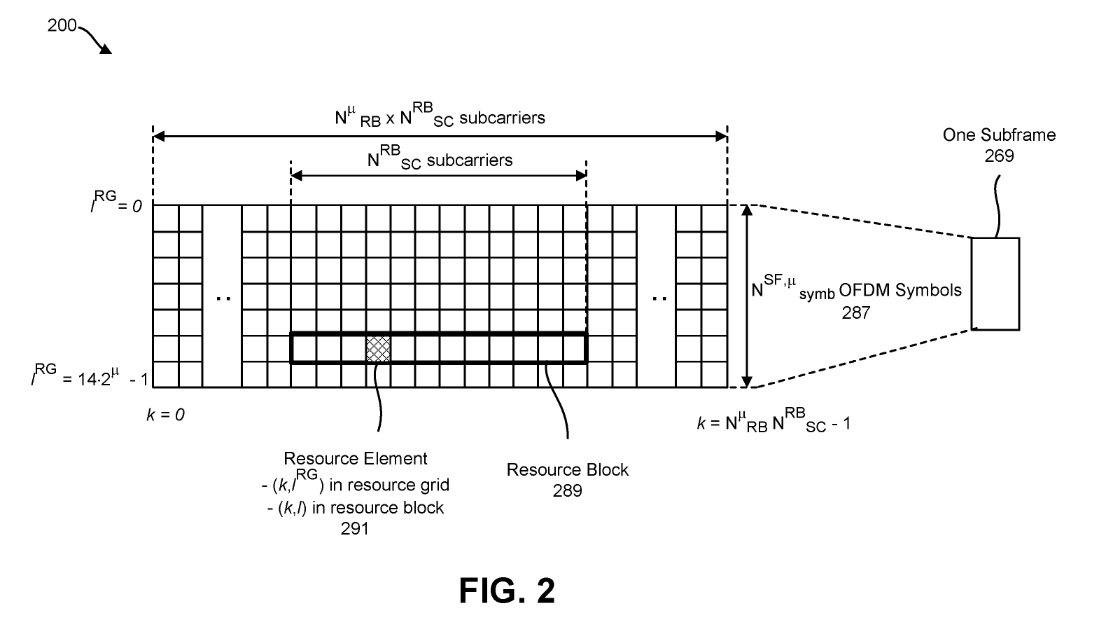

FIG. 2 is a diagram illustrating one example of a resource grid 200. The resource grid 200 illustrated in FIG. 2 may be applicable for both downlink and uplink and may be utilized in some implementations of the systems and methods disclosed herein. More detail regarding the resource grid is given in connection with FIG. 1.

In FIG. 2, one subframe 269 may include one or several slots. For a given numerology μ, N^{μ}_{RB} is bandwidth configuration of the serving cell, expressed in multiples of N^{RB}_{sc}, where N^{RB}_{sc} is a resource block 289 size in the frequency domain expressed as a number of subcarriers, and N^{SF,μ}_{sym}b is the number of Orthogonal Frequency Division Multiplexing (OFDM) symbols 287 in a subframe 269. In other words, For each numerology μ and for each of downlink and uplink, a resource grid of N^{μ}_{RB}N^{RB}_{sc} subcarriers and N^{SF,μ} symb OFDM symbols may be defined. There may be one resource grid per antenna port p, per subcarrier spacing configuration (i.e. numerology) μ, and per transmission direction (uplink or downlink). A resource block 289 may include a number of resource elements (RE) 291.

Multiple OFDM numerologies (also referred to as just numerologies) are supported as given by Table X1. Each of the numerologies may be tied to its own subcarrier spacing Δf.

TABLE X1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |

For subcarrier spacing configuration μ, slots are numbered n^{μ}ₛ∈{0, . . . , N^{SF,μ}ₛₗₒₜ−1} in increasing order within a subframe and n^{μ}_{s,f}∈{0, . . . , N^{frame,μ}ₛₗₒₜ−1} in increasing order within a frame. There are N^{slot,μ}_{symb} consecutive OFDM symbols in a slot where N^{slot,μ}_{symb} depends on the subcarrier spacing used and the slot configuration as given by Table X2 for normal cyclic prefix and Table X3 for extended cyclic prefix. The number of consecutive OFDM symbols per subframe is N^{SF,μ}_{symb}=N^{slot,μ}_{symb}.N^{SF,μ}ₛₗₒₜ. The start of slot n^{μ}ₛ in a subframe is aligned in time with the start of OFDM symbol n^{μ}ₛN^{slot,μ}_{symb} in the same subframe. Not all UEs may be capable of simultaneous transmission and reception, implying that not all OFDM symbols in a downlink slot or an uplink slot may be used.

TABLE X2

| | Slot configuration | | | | | |
|---|---|---|---|---|---|---|
| | 0 | | | 1 | | |
| μ | N^{slot,μ}_{symb} | N^{frame,μ}ₛₗₒₜ | N^{SF,μ}ₛₗₒₜ | N^{slot,μ}_{symb} | N^{frame,μ}ₛₗₒₜ | N^{SF,μ}ₛₗₒₜ |
| 0 | 14 | 10 | 1 | 7 | 20 | 2 |
| 1 | 14 | 20 | 2 | 7 | 40 | 4 |
| 2 | 14 | 40 | 4 | 7 | 80 | 8 |
| 3 | 14 | 80 | 8 | — | — | — |
| 4 | 14 | 160 | 16 | — | — | — |
| 5 | 14 | 320 | 32 | — | — | — |

TABLE X3

| | Slot configuration | | | | | |
|---|---|---|---|---|---|---|
| | 0 | | | 1 | | |
| μ | N^{slot,μ}_{symb} | N^{frame,μ}ₛₗₒₜ | N^{SF,μ}ₛₗₒₜ | N^{slot,μ}_{symb} | N^{frame,μ}ₛₗₒₜ | N^{SF,μ}ₛₗₒₜ |
| 2 | 12 | 40 | 4 | 6 | 80 | 8 |

For a PCell, N^{μ}_{RB} is broadcast as a part of system information. For an SCell (including a Licensed-Assisted Access (LAA) SCell), N^{μ}_{RB} is configured by a RRC message dedicated to a UE 102. For PDSCH mapping, the available RE 291 may be the RE 291 whose index 1 fulfils 1≥1_{data,start} and/or 1_{data,end}≥1 in a subframe.

The OFDM access scheme with cyclic prefix (CP) may be employed, which may be also referred to as CP-OFDM. In the downlink, PDCCH, EPDCCH (Enhanced Physical Downlink Control Channel), PDSCH and the like may be transmitted. A radio frame may include a set of subframes 269 (e.g. 10 subframes). The RB is a unit for assigning downlink radio resources, defined by a predetermined bandwidth (RB bandwidth) and one or more OFDM symbols.

A physical resource block is defined as N^{RB}_{sc}=12 consecutive subcarriers in the frequency domain. Physical resource blocks are numbered from 0 to N^{μ}_{RB}−1 in the frequency domain. The relation between the physical resource block number n_{PRB} in the frequency domain and resource elements (k,l) is given by n_{PRB}=floor(k/N^{RB}_{sc}). The RB includes twelve sub-carriers in frequency domain and one or more OFDM symbols in time domain. A region defined by one sub-carrier in frequency domain and one OFDM symbol in time domain is referred to as a resource element (RE) and is uniquely identified by the index pair (k,l^{RG}) in the resource grid, where k=0, . . . , N^{μ}_{RB}N^{RB}_{sc}−1 and l^{RG}=0, . . . , N^{SF,μ}_{symb}−1 are indices in the frequency and time domains, respectively. Moreover, RE is uniquely identified by the index pair (k,l) in a RB, where l are indices in the time domain. When referring to a resource element in a slot the index pair (k,l) is used where l=0, . . . , N^{slot,μ}_{symb}−1. While subframes in one component carrier (CC) are discussed herein, subframes are defined for each CC and subframes are substantially in synchronization with each other among CCs.

In the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). In the uplink, PUCCH, PDSCH, Physical Random Access Channel (PRACH) and the like may be transmitted.

A UE 102 may be instructed to receive or transmit using a subset of the resource grid only. The set of resource blocks a UE is referred to as a carrier bandwidth part and may be configured to receive or transmit upon are numbered from 0 to N^{μ}_{RB}−1 in the frequency domain. The UE may be configured with one or more carrier bandwidth parts, each of which may have the same or different numerology.

One or more sets of PRB(s) may be configured for DL control channel monitoring. In other words, a control resource set is, in the frequency domain, a set of PRBs within which the UE 102 attempts to blindly decode downlink control information (i.e., monitor downlink control information (DCI)), where the PRBs may or may not be frequency contiguous, a UE 102 may have one or more control resource sets, and one DCI message may be located within one control resource set. In the frequency-domain, a PRB is the resource unit size (which may or may not include DMRS) for a control channel. A DL shared channel may start at a later OFDM symbol than the one(s) which carries the detected DL control channel. Alternatively, the DL shared channel may start at (or earlier than) an OFDM symbol than the last OFDM symbol which carries the detected DL control channel. In other words, dynamic reuse of at least part of resources in the control resource sets for data for the same or a different UE 102, at least in the frequency domain may be supported.

Namely, the UE 102 may monitor a set of PDCCH candidates. Here, the PDCCH candidates may be candidates for which the PDCCH may possibly be assigned and/or transmitted. A PDCCH candidate is composed of one or more control channel elements (CCEs). The term “monitor” means that the UE 102 attempts to decode each PDCCH in the set of PDCCH candidates in accordance with all the DCI formats to be monitored.

The set of PDCCH candidates that the UE 102 monitors may be also referred to as a search space. That is, the search space is a set of resource that may possibly be used for PDCCH transmission.

Furthermore, a common search space (CSS) and a user-equipment search space (USS) are set (or defined, configured) in the PDCCH resource region. For example, the CSS may be used for transmission of DCI to a plurality of the UEs 102. That is, the CSS may be defined by a resource common to a plurality of the UEs 102. For example, the CSS is composed of CCEs having numbers that are predetermined between the gNB 160 and the UE 102. For example, the CSS is composed of CCEs having indices 0 to 15.

Here, the CSS may be used for transmission of DCI to a specific UE 102. That is, the gNB 160 may transmit, in the CSS, DCI format(s) intended for a plurality of the UEs 102 and/or DCI format(s) intended for a specific UE 102. There may be one or more types of CSS. For example, Type 0 PDCCH CSS may be defined for a DCI format scrambled by a System Information-Radio Network Temporary Identifier (SI-RNTI) on PCell. Type 1 PDCCH CSS may be defined for a DCI format scrambled by an Interval-(INT-)RNTI, where if a UE 102 is configured by higher layers to decode a DCI format with CRC scrambled by the INT-RNTI and if the UE 102 detects the DCI format with CRC scrambled by the INT-RNTI, the UE 102 may assume that no transmission to the UE 102 is present in OFDM symbols and resource blocks indicated by the DCI format. Type 2 PDCCH CSS may be defined for a DCI format scrambled by a Random Access-(RA-)RNTI. Type 3 PDCCH CSS may be defined for a DCI format scrambled by a Paging-(P-)RNTI. Type 4 PDCCH CSS may be defined for a DCI format scrambled by the other RNTI (e.g. Transmit Power Control-(TPC-)RNTI).

The USS may be used for transmission of DCI to a specific UE 102. That is, the USS is defined by a resource dedicated to a certain UE 102. That is, the USS may be defined independently for each UE 102. For example, the USS may be composed of CCEs having numbers that are determined based on a RNTI assigned by the gNB 160, a slot number in a radio frame, an aggregation level, or the like.

Here, the RNTI(s) may include C-RNTI (Cell-RNTI), Temporary C-RNTI. Also, the USS (the position(s) of the USS) may be configured by the gNB 160. For example, the gNB 160 may configure the USS by using the RRC message. That is, the base station may transmit, in the USS, DCI format(s) intended for a specific UE 102.

Here, the RNTI assigned to the UE 102 may be used for transmission of DCI (transmission of PDCCH). Specifically, CRC (Cyclic Redundancy Check) parity bits (also referred to simply as CRC), which are generated based on DCI (or DCI format), are attached to DCI, and, after attachment, the CRC parity bits are scrambled by the RNTI. The UE 102 may attempt to decode DCI to which the CRC parity bits scrambled by the RNTI are attached, and detects PDCCH (i.e., DCI, DCI format). That is, the UE 102 may decode PDCCH with the CRC scrambled by the RNTI.

When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

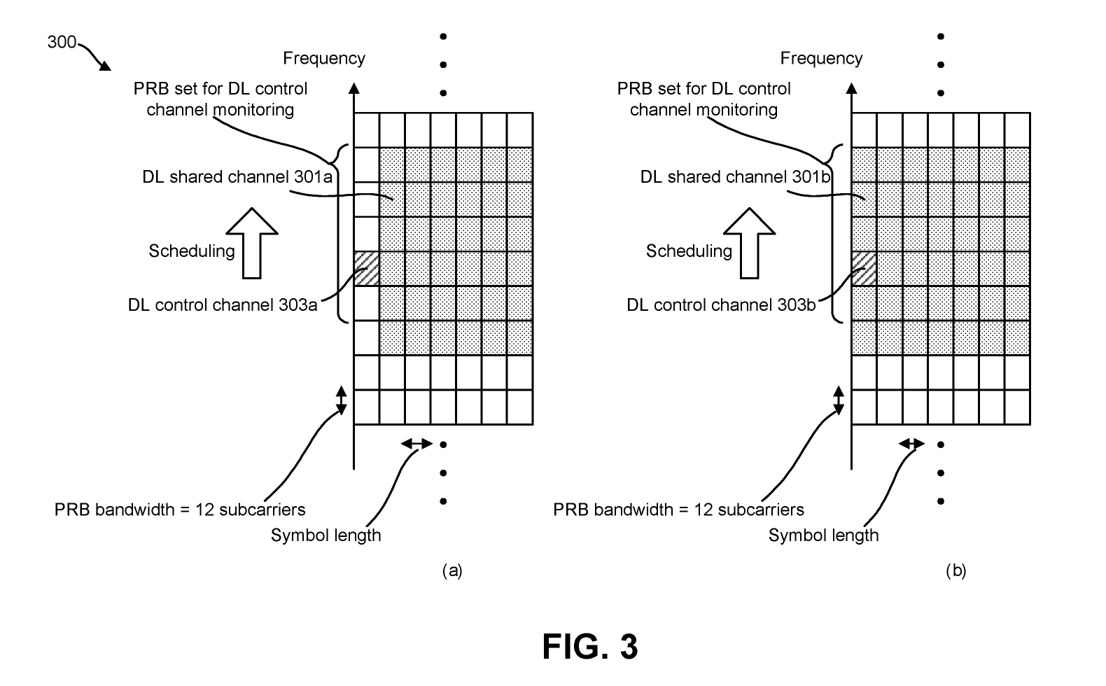

FIG. 3 shows examples 300 of DL control channel monitoring regions. One or more sets of PRB(s) may be configured for DL control channel monitoring. In other words, a control resource set is, in the frequency domain, a set of PRBs within which the UE 102 attempts to blindly decode downlink control information (i.e., monitor downlink control information (DCI)), where the PRBs may or may not be frequency contiguous, a UE 102 may have one or more control resource sets, and one DCI message may be located within one control resource set. In the frequency-domain, a PRB is the resource unit size (which may or may not include DM-RS) for a control channel. A DL shared channel 301 may start at a later OFDM symbol than the one(s) which carries the detected DL control channel 303. Alternatively, the DL shared channel 301 may start at (or earlier than) an OFDM symbol than the last OFDM symbol which carries the detected DL control channel 303. In other words, dynamic reuse of at least part of resources in the control resource sets for data for the same or a different UE 102, at least in the frequency domain may be supported.

Namely, the UE 102 may monitor a set of PCCH (e.g., PDCCH) candidates. Here, the PCCH candidates may be candidates for which the PCCH may possibly be assigned and/or transmitted. A PCCH candidate is composed of one or more control channel elements (CCEs). The term “monitor” means that the UE 102 attempts to decode each PDCCH in the set of PDCCH candidates in accordance with all the DCI formats to be monitored.

The set of PDCCH candidates that the UE 102 monitors may be also referred to as a search space. That is, the search space is a set of resource that may possibly be used for PCCH transmission.

Furthermore, a common search space (CSS) and a user-equipment search space (USS) are set (or defined, configured) in the PCCH resource region. For example, the CSS may be used for transmission of DCI to a plurality of the UEs 102. That is, the CSS may be defined by a resource common to a plurality of the UEs 102. For example, the CSS is composed of CCEs having numbers that are predetermined between the gNB 160 and the UE 102. For example, the CSS is composed of CCEs having indices 0 to 15.

Here, the CSS may be used for transmission of DCI to a specific UE 102. That is, the gNB 160 may transmit, in the CSS, DCI format(s) intended for a plurality of the UEs 102 and/or DCI format(s) intended for a specific UE 102.

The USS may be used for transmission of DCI to a specific UE 102. That is, the USS is defined by a resource dedicated to a certain UE 102. That is, the USS may be defined independently for each UE 102. For example, the USS may be composed of CCEs having numbers that are determined based on a Radio Network Temporary Identifier (RNTI) assigned by the gNB 160, a slot number in a radio frame, an aggregation level, or the like.

Here, the RNTI(s) may include C-RNTI (Cell-RNTI), Temporary C-RNTI. Also, the USS (the position(s) of the USS) may be configured by the gNB 160. For example, the gNB 160 may configure the USS by using the RRC message. That is, the base station may transmit, in the USS, DCI format(s) intended for a specific UE 102.

Here, the RNTI assigned to the UE 102 may be used for transmission of DCI (transmission of PCCH). Specifically, CRC (Cyclic Redundancy Check) parity bits (also referred to simply as CRC), which are generated based on DCI (or DCI format), are attached to DCI, and, after attachment, the CRC parity bits are scrambled by the RNTI. The UE 102 may attempt to decode DCI to which the CRC parity bits scrambled by the RNTI are attached, and detects PCCH (i.e., DCI, DCI format). That is, the UE 102 may decode PCCH with the CRC scrambled by the RNTI.

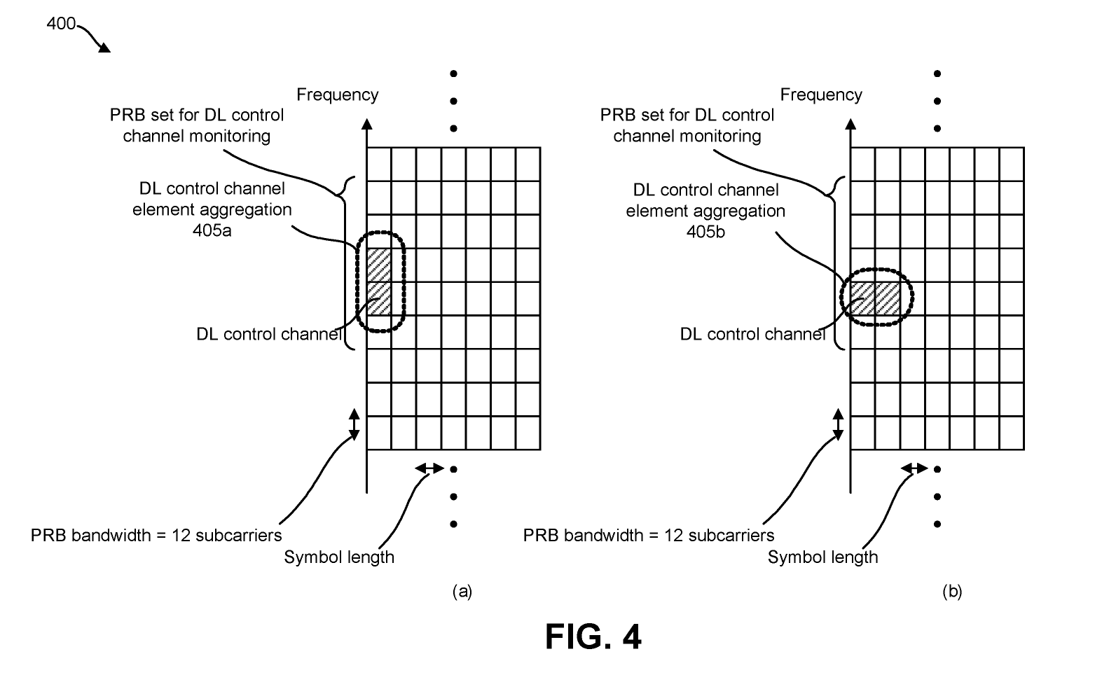

FIG. 4 shows examples 400 of DL control channel which includes more than one control channel elements. When the control resource set spans multiple OFDM symbols, a control channel candidate may be mapped to multiple OFDM symbols or may be mapped to a single OFDM symbol. One DL control channel element may be mapped on REs defined by a single PRB and a single OFDM symbol. If more than one DL control channel elements are used for a single DL control channel transmission, DL control channel element aggregation 405 may be performed.

The number of aggregated DL control channel elements is referred to as DL control channel element aggregation level. The DL control channel element aggregation level may be 1 or 2 to the power of an integer. The gNB 160 may inform a UE 102 of which control channel candidates are mapped to each subset of OFDM symbols in the control resource set. If one DL control channel is mapped to a single OFDM symbol and does not span multiple OFDM symbols, the DL control channel element aggregation is performed within an OFDM symbol, namely multiple DL control channel elements within an OFDM symbol are aggregated. Otherwise, DL control channel elements in different OFDM symbols can be aggregated.

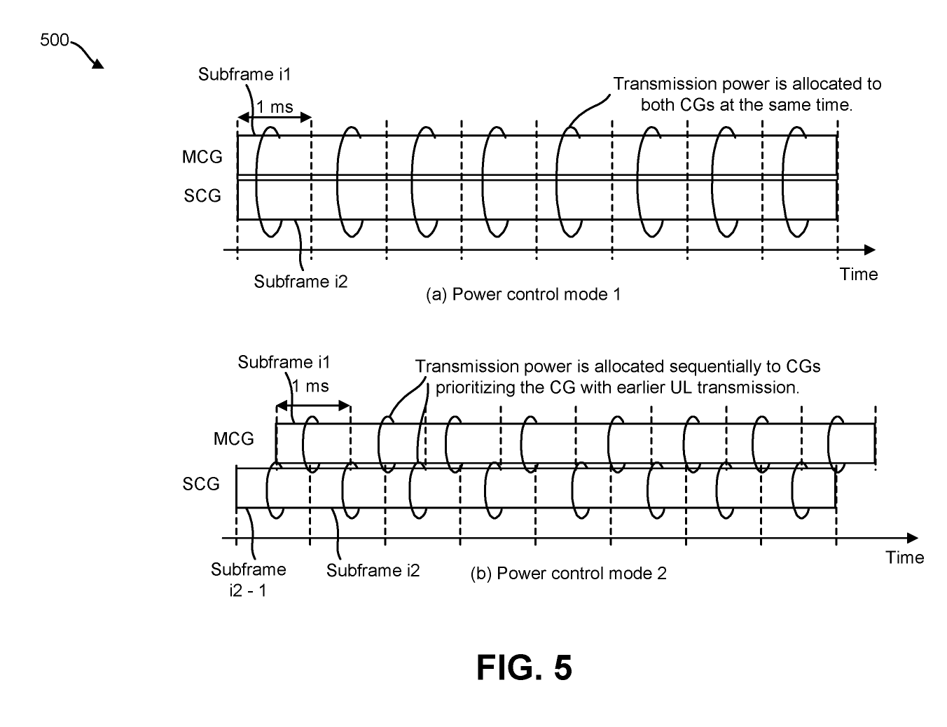

FIG. 5 is a diagram illustrating examples 500 of power control modes (PCMs) that may be implemented in accordance with some examples of the systems and methods disclosed herein. In particular, FIG. 5 illustrates (a) PCM 1, where transmission power is allocated to both cell groups (CGs) (e.g., MCG and SCG) at the same time. Subframe it for the MCG and subframe i2 for the SCG are shown. FIG. 5 also illustrates (b) PCM 2, where transmission power is allocated sequentially to CGs prioritizing the CG with earlier UL transmission. A subframe i1 for the MCG and subframes i2−1 and i2 for the SCG are also shown.

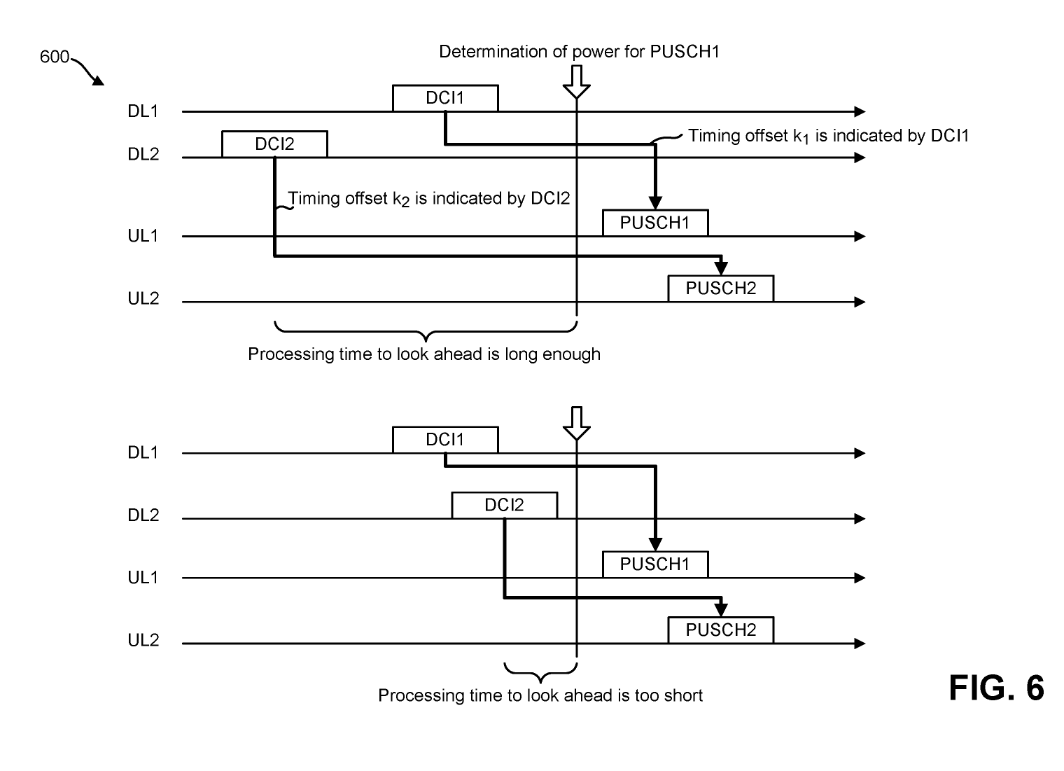

FIG. 6 is a diagram illustrating examples 600 of a timing condition for application of look-ahead (LA) in accordance with some examples of the systems and methods disclosed herein. More specifically, FIG. 6 illustrates examples of looking ahead depending on scheduling timing. For instance, if a colliding UL transmission was scheduled more than t OFDM symbol(s) before the collided UL transmission, the UE may look ahead (e.g., perform LA processing). Otherwise, the UE may not perform LA processing). In a first example in FIG. 6, the time is long enough for LA processing. In a second example in FIG. 6, the time is too short for LA processing.

In FIG. 6, timing offsets k₁ and k₂ are shown. The timing offsets k₁ and k₂ may represent respective timing offsets between the DCI(PDCCH) for PUSCH scheduling and the actual transmission timing of the scheduled PUSCH.

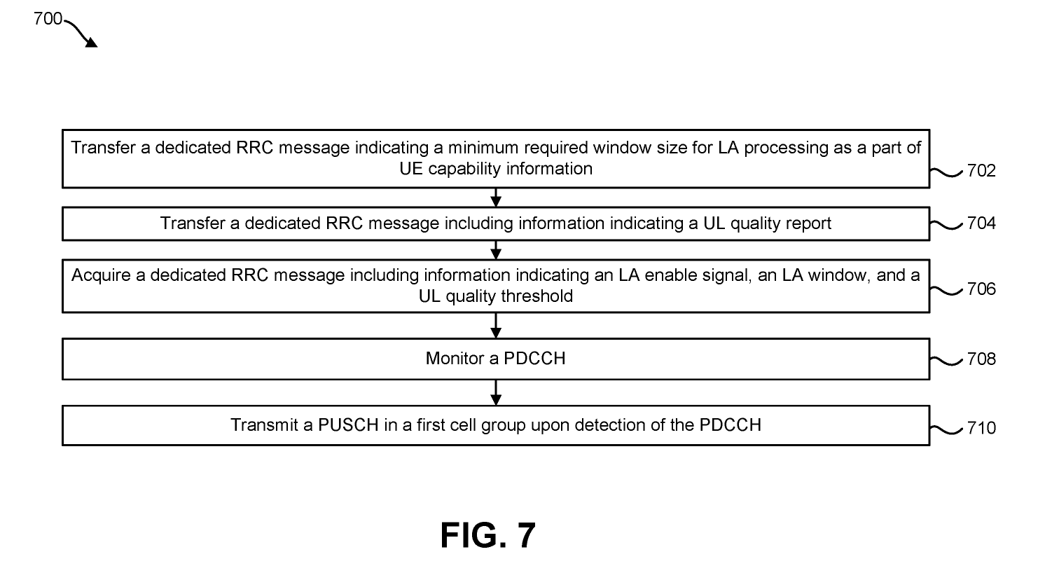

FIG. 7 is a flow diagram illustrating one example of a method 700 for dual connectivity. The method 700 may be performed by the UE 102 described in connection with FIG. 1. The UE 102 may transfer 702 a dedicated RRC message indicating a minimum required window size for LA as part of UE capability information.

The UE 102 may transfer 704 a dedicated RRC message including information indicating a UL quality report. The UE 102 may acquire 706 a dedicated RRC configuration message including information indicating an LA enable signal, an LA window, and/or a UL quality threshold.

The UE 102 may monitor 708 a PDCCH. The PDCCH may carry a DCI format that schedules a PUSCH.

The UE 102 may transmit 710 a PUSCH in a first cell group (CG) upon detection of the PDCCH. In a case that the PUSCH is transmitted within the LA window, a first transmit power of the PUSCH may be derived using a second transmit power of a physical uplink channel of a second cell group. In a case the PUSCH is transmitted outside the LA window, the first transmit power of the PUSCH may be derived without using the second transmit power of the physical uplink channel of the second cell group. A transmission of the physical uplink channel may start after a transmission of the PUSCH starts.

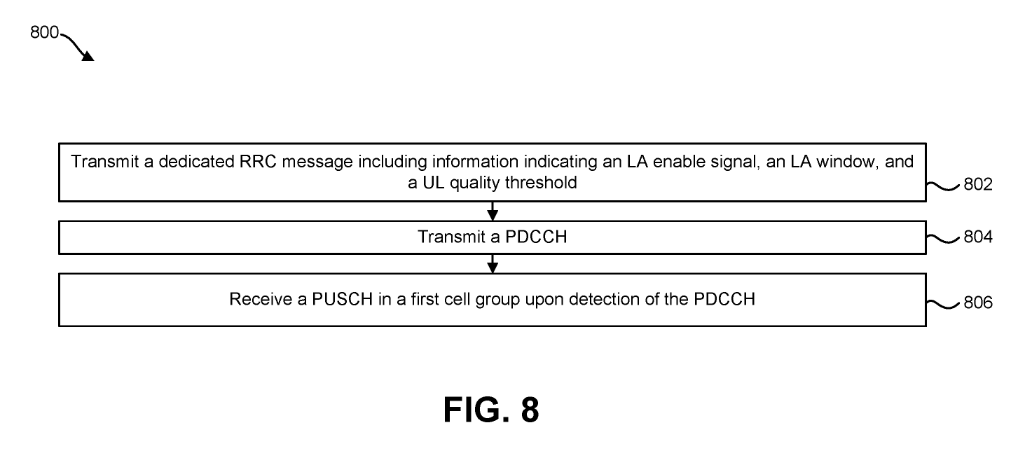

FIG. 8 is a flow diagram illustrating one example of a method 800 for dual connectivity. The method 800 may be performed by a base station (e.g., the gNB 160 described in connection with FIG. 1). The gNB 160 may transmit 802 a dedicated RRC message including information indicating an LA enable signal, an LA window, and/or a UL quality threshold.

The gNB 160 may transmit 804 a PDCCH. The PDCCH may carry a DCI format that schedules a PUSCH.

The gNB 160 may receive 806 the PUSCH in a first CG upon detection of the PDCCH. In a case that the PUSCH is transmitted within the LA window, a first transmit power of the PUSCH may be derived using a second transmit power of a physical uplink channel of a second cell group. In a case the PUSCH is transmitted outside the LA window, the first transmit power of the PUSCH may be derived without using the second transmit power of the physical uplink channel of the second cell group. A transmission of the physical uplink channel may start after a transmission of the PUSCH starts.

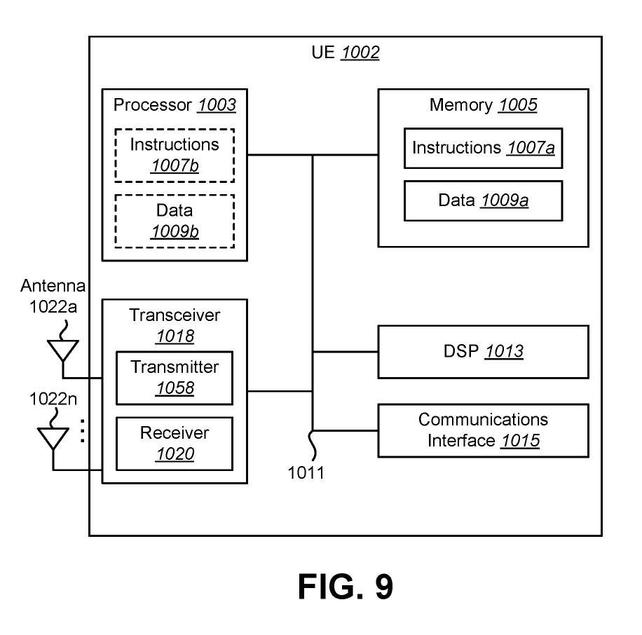

FIG. 9 illustrates various components that may be utilized in a UE 1002. The UE 1002 described in connection with FIG. 9 may be implemented in accordance with the UE 102 described in connection with FIG. 1. The UE 1002 includes a processor 1003 that controls operation of the UE 1002. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement the methods described above.

The UE 1002 may also include a housing that contains one or more transmitters 1058 and one or more receivers 1020 to allow transmission and reception of data. The transmitter(s) 1058 and receiver(s) 1020 may be combined into one or more transceivers 1018. One or more antennas 1022a-n are attached to the housing and electrically coupled to the transceiver 1018.

The various components of the UE 1002 are coupled together by a bus system 1011, which may include a power bus, a control signal bus and a status signal bus, in addition to a data bus. However, for the sake of clarity, the various buses are illustrated in FIG. 9 as the bus system 1011. The UE 1002 may also include a digital signal processor (DSP) 1013 for use in processing signals. The UE 1002 may also include a communications interface 1015 that provides user access to the functions of the UE 1002. The UE 1002 illustrated in FIG. 9 is a functional block diagram rather than a listing of specific components.

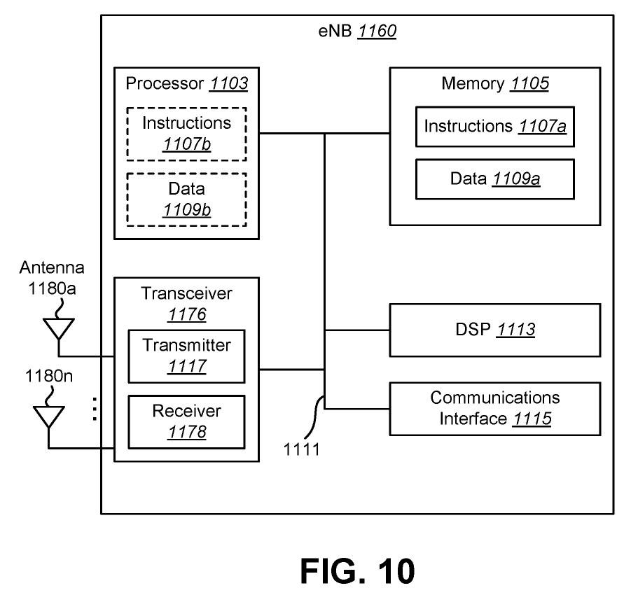

FIG. 10 illustrates various components that may be utilized in a gNB 1160. The gNB 1160 described in connection with FIG. 10 may be implemented in accordance with the gNB 160 described in connection with FIG. 1. The gNB 1160 includes a processor 1103 that controls operation of the gNB 1160. The processor 1103 may also be referred to as a central processing unit (CPU). Memory 1105, which may include read-only memory (ROM), random access memory (RAM), a combination of the two or any type of device that may store information, provides instructions 1107a and data 1109a to the processor 1103. A portion of the memory 1105 may also include non-volatile random access memory (NVRAM). Instructions 1107b and data 1109b may also reside in the processor 1103. Instructions 1107b and/or data 1109b loaded into the processor 1103 may also include instructions 1107a and/or data 1109a from memory 1105 that were loaded for execution or processing by the processor 1103. The instructions 1107b may be executed by the processor 1103 to implement the methods described above.

The gNB 1160 may also include a housing that contains one or more transmitters 1117 and one or more receivers 1178 to allow transmission and reception of data. The transmitter(s) 1117 and receiver(s) 1178 may be combined into one or more transceivers 1176. One or more antennas 1180a-n are attached to the housing and electrically coupled to the transceiver 1176.

The various components of the gNB 1160 are coupled together by a bus system 1111, which may include a power bus, a control signal bus and a status signal bus, in addition to a data bus. However, for the sake of clarity, the various buses are illustrated in FIG. 10 as the bus system 1111. The gNB 1160 may also include a digital signal processor (DSP) 1113 for use in processing signals. The gNB 1160 may also include a communications interface 1115 that provides user access to the functions of the gNB 1160. The gNB 1160 illustrated in FIG. 10 is a functional block diagram rather than a listing of specific components.

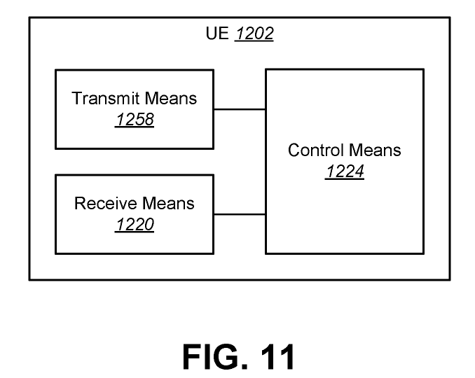

FIG. 11 is a block diagram illustrating one implementation of a UE 1202 in which systems and methods for performing uplink transmissions may be implemented. The UE 1202 includes transmit means 1258, receive means 1220 and control means 1224. The transmit means 1258, receive means 1220 and control means 1224 may be configured to perform one or more of the functions described in connection with FIG. 1 above. FIG. 9 above illustrates one example of a concrete apparatus structure of FIG. 11. Other various structures may be implemented to realize one or more of the functions of FIG. 1. For example, a DSP may be realized by software.

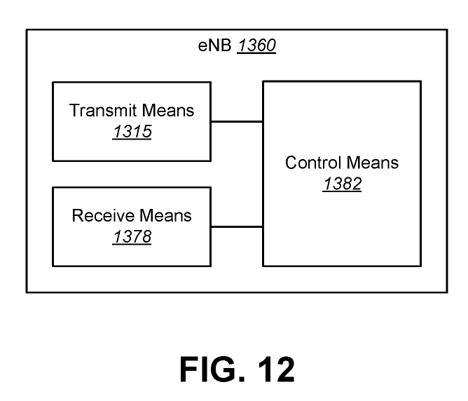

FIG. 12 is a block diagram illustrating one implementation of a gNB 1360 in which systems and methods for performing uplink transmissions may be implemented. The gNB 1360 includes transmit means 1317, receive means 1378 and control means 1382. The transmit means 1317, receive means 1378 and control means 1382 may be configured to perform one or more of the functions described in connection with FIG. 1 above. FIG. 10 above illustrates one example of a concrete apparatus structure of FIG. 12. Other various structures may be implemented to realize one or more of the functions of FIG. 1. For example, a DSP may be realized by software.

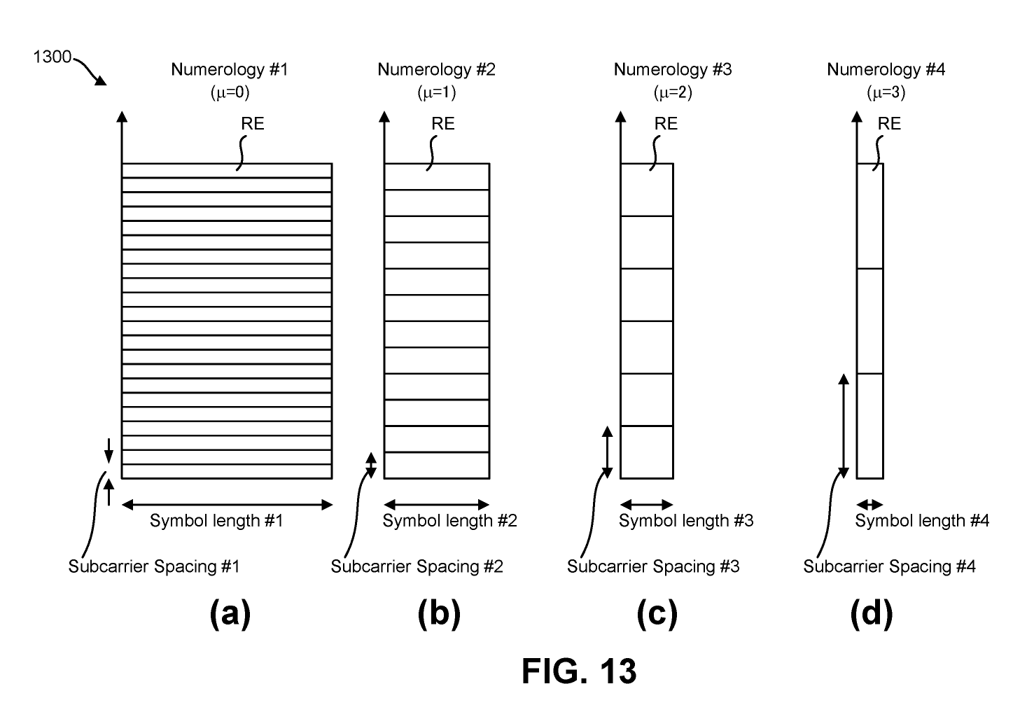

FIG. 13 shows examples of several numerologies 1300. The numerology #1 (μ=0) (a) may be a basic numerology. For example, a RE of the basic numerology is defined with subcarrier spacing of 15 kHz in frequency domain and 2048κTs+CP length (e.g., 512κTs, 160κTs or 144κTs) in time domain, where Ts denotes a baseband sampling time unit defined as 1/(15000*2048) seconds. For the μ-th numerology, the subcarrier spacing may be equal to 15*2^{μ} and the effective OFDM symbol length NuTs=2048*2^{-μ}κTs. It may cause the symbol length is 2048*2^{-μ}κTs+CP length (e.g., 512*2^{-μ}κTs, 160*2^{-μ}κTs or 144*2^{-μ}κTs). Note that κ=64, Ts=1/(Δfₘₐₓ·N_{f}), Δfₘₐₓ=480·10³ Hz (i.e. Δf for μ=5), and N_{f}=4096. In other words, the subcarrier spacing of the μ+1-th numerology is a double of the one for the μ-th numerology, and the symbol length of the μ+1-th numerology is a half of the one for the μ-th numerology. FIG. 13 shows four numerologies, but the system may support another number of numerologies.

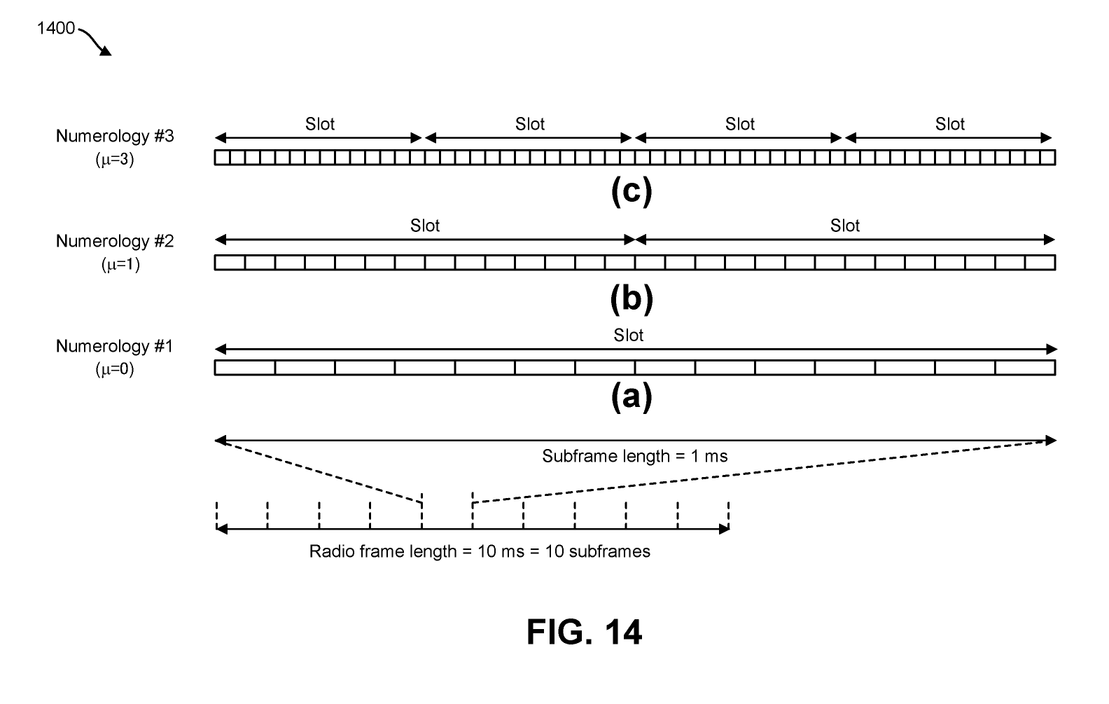

FIG. 14 shows a set of examples of subframe structures 1400 for the numerologies that are shown in FIG. 13. These examples are based on the slot configuration set to 0. A slot includes 14 symbols, the slot length of the μ+1-th numerology is a half of the one for the μ-th numerology, and eventually the number of slots in a subframe (i.e., 1 ms) becomes double. It may be noted that a radio frame may include 10 subframes, and the radio frame length may be equal to 10 ms.

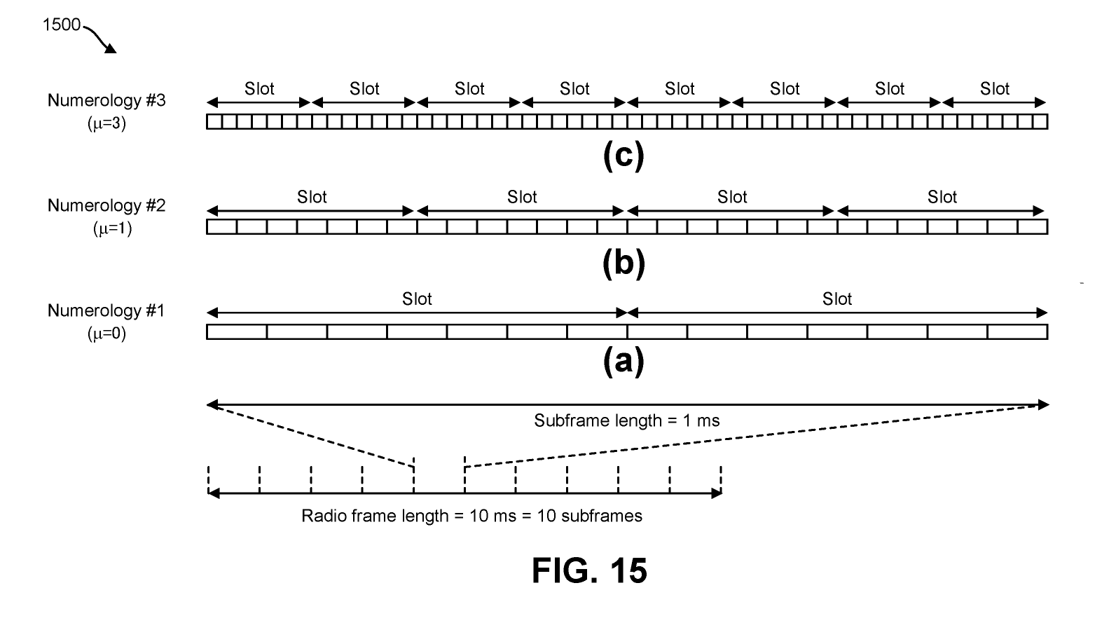

FIG. 15 shows another set of examples of subframe structures 1500 for the numerologies that are shown in FIG. 13. These examples are based on the slot configuration set to 1. A slot includes 7 symbols, the slot length of the μ+1-th numerology is a half of the one for the μ-th numerology, and eventually the number of slots in a subframe (i.e., 1 ms) becomes double.

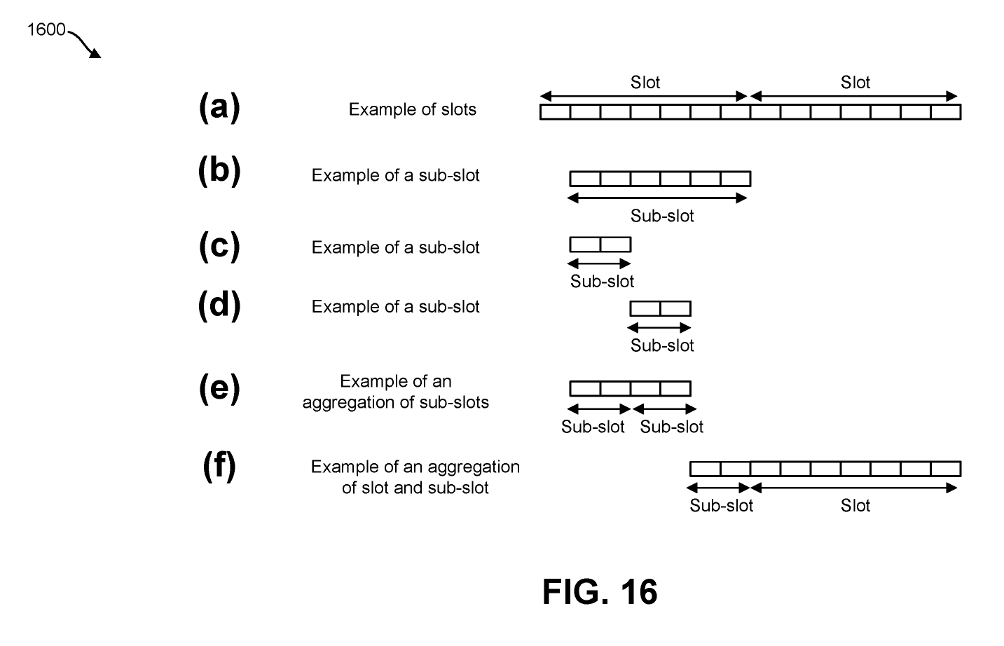

FIG. 16 shows examples 1600 of slots and sub-slots. If sub-slot (i.e. time domain resource allocation in unites of OFDM symbol or a set of a few OFDM symbols) is not configured by higher layer, the UE 102 and the gNB 160 may only use a slot as a scheduling unit. More specifically, a given transport block may be allocated to a slot. If the sub-slot is configured by higher layer, the UE 102 and the gNB 160 may use the sub-slot as well as the slot. The sub-slot may include one or more OFDM symbols. The maximum number of OFDM symbols that constitute the sub-slot may be N^{SF,μ}_{symb}−1. The sub-slot length may be configured by higher layer signaling. Alternatively, the sub-slot length may be indicated by a physical layer control channel (e.g., by DCI format). The sub-slot may start at any symbol within a slot unless it collides with a control channel. There could be restrictions of mini-slot length based on restrictions on starting position. For example, the sub-slot with the length of N^{SF,μ}_{symb}−1 may start at the second symbol in a slot. The starting position of a sub-slot may be indicated by a physical layer control channel (e.g., by DCI format). Alternatively, the starting position of a sub-slot may be derived from information (e.g., search space index, blind decoding candidate index, frequency and/or time resource indices, PRB index, a control channel element index, control channel element aggregation level, an antenna port index, etc.) of the physical layer control channel which schedules the data in the concerned sub-slot. In cases when the sub-slot is configured, a given transport block may be allocated to either a slot, a sub-slot, aggregated sub-slots or aggregated sub-slot(s) and slot. This unit may also be a unit for HARQ-ACK bit generation.

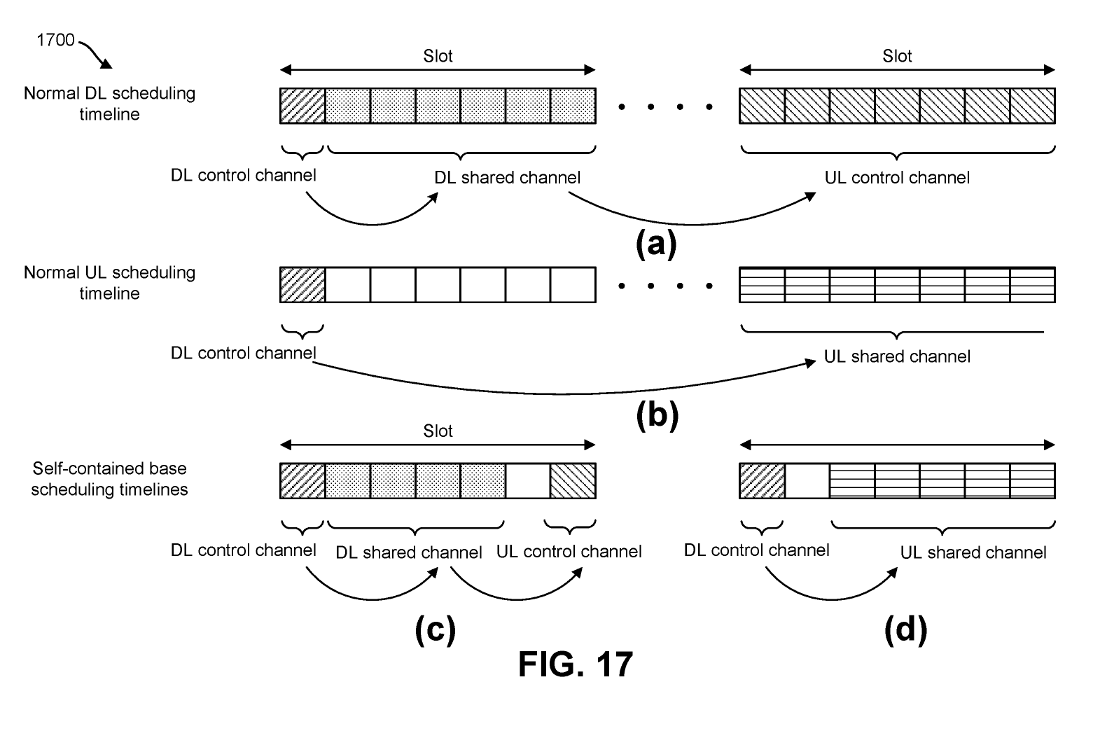

FIG. 17 shows examples of scheduling timelines 1700. For a normal DL scheduling timeline, DL control channels are mapped the initial part of a slot. The DL control channels schedule DL shared channels in the same slot. HARQ-ACKs for the DL shared channels (i.e., HARQ-ACKs each of which indicates whether or not transport block in each DL shared channel is detected successfully) are reported via UL control channels in a later slot. In this instance, a given slot may contain either one of DL transmission and UL transmission. For a normal UL scheduling timeline, DL control channels are mapped the initial part of a slot. The DL control channels schedule UL shared channels in a later slot. For these cases, the association timing (time shift) between the DL slot and the UL slot may be fixed or configured by higher layer signaling. Alternatively, it may be indicated by a physical layer control channel (e.g., the DL assignment DCI format, the UL grant DCI format, or another DCI format such as UE-common signaling DCI format which may be monitored in common search space).

For a self-contained base DL scheduling timeline, DL control channels are mapped the initial part of a slot. The DL control channels schedules DL shared channels in the same slot. HARQ-ACKs for the DL shared channels are reported UL control channels which are mapped at the ending part of the slot. For a self-contained base UL scheduling timeline, DL control channels are mapped the initial part of a slot. The DL control channels schedules UL shared channels in the same slot. For these cases, the slot may contain DL and UL portions, and there may be a guard period between the DL and UL transmissions. The use of self-contained slot may be upon a configuration of self-contained slot. Alternatively, the use of self-contained slot may be upon a configuration of the sub-slot. Yet alternatively, the use of self-contained slot may be upon a configuration of shortened physical channel (e.g., PDSCH, PUSCH, PUCCH, etc.).

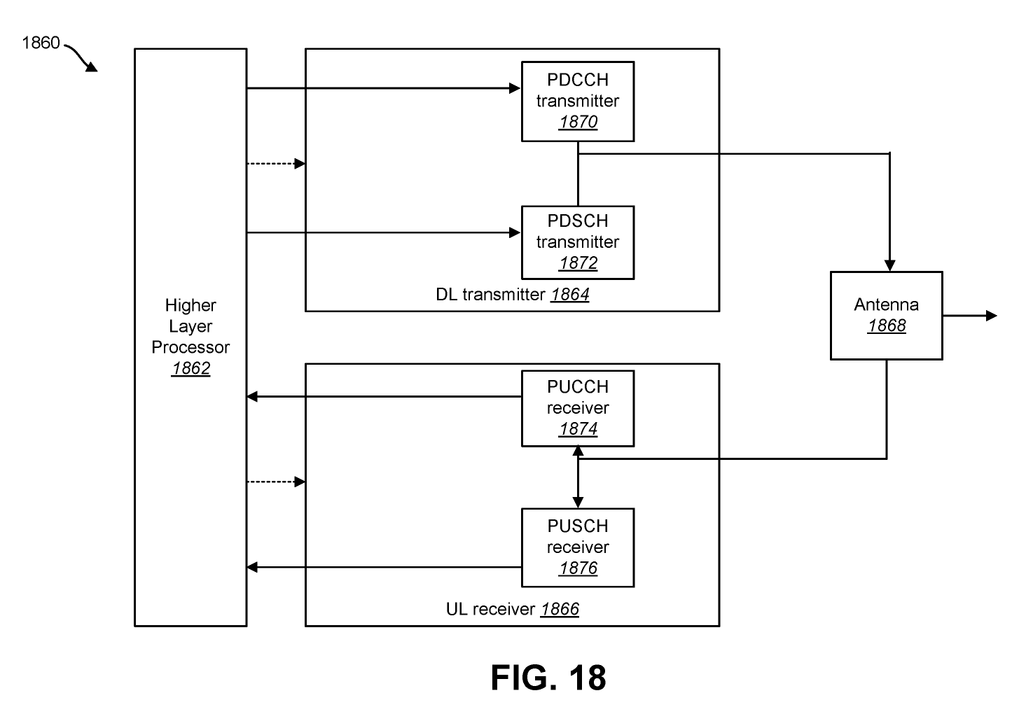

FIG. 18 is a block diagram illustrating one implementation of a gNB 1860. The gNB 1860 may include a higher layer processor 1862, a DL transmitter 1864, a UL receiver 1866, and antennas 1868. The DL transmitter 1864 may include a PDCCH transmitter 1870 and a PDSCH transmitter 1872. The UL receiver 1866 may include a PUCCH receiver 1874 and a PUSCH receiver 1876. The higher layer processor 1862 may manage physical layer's behaviors (the DL transmitter's and the UL receiver's behaviors) and provide higher layer parameters to the physical layer. The higher layer processor 1862 may obtain transport blocks from the physical layer. The higher layer processor 1862 may send/acquire higher layer messages such as an RRC message and MAC message to/from a UE's higher layer. The higher layer processor 1862 may provide the PDSCH transmitter 1872 transport blocks and provide the PDCCH transmitter 1870 transmission parameters related to the transport blocks. The UL receiver 1866 may receive multiplexed uplink physical channels and uplink physical signals via receiving antennas and de-multiplex them. The PUCCH receiver 1874 may provide the higher layer processor UCI. The PUSCH receiver 1876 may provide the higher layer processor 1862 received transport blocks.

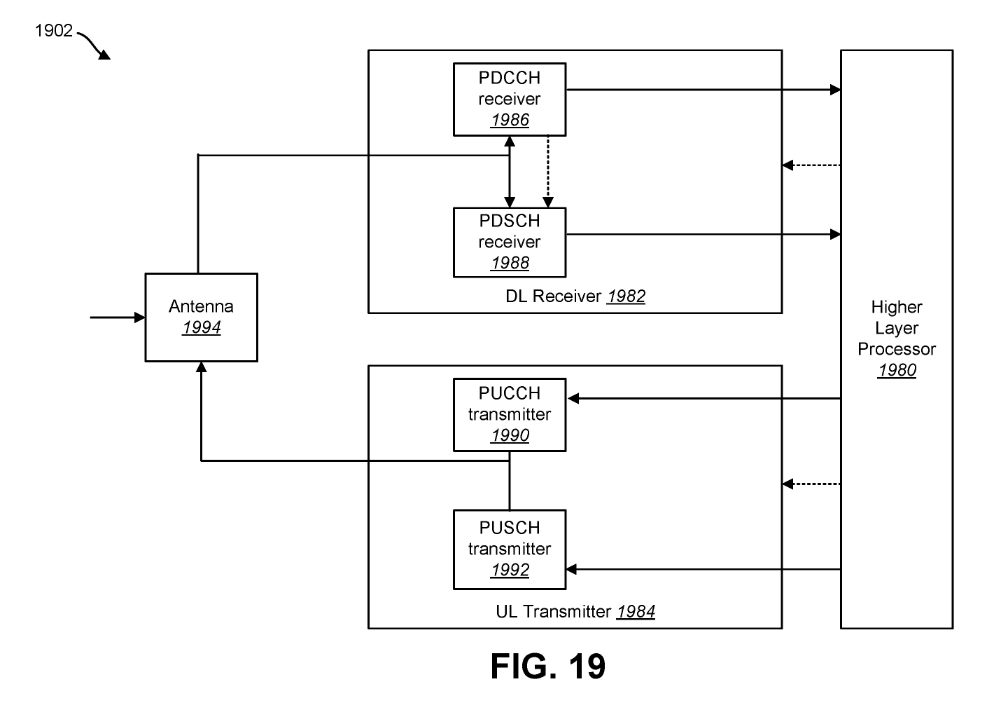

FIG. 19 is a block diagram illustrating one implementation of a UE 1902. The UE 1902 may include a higher layer processor 1980, a UL transmitter 1984, a DL receiver 1982, and antennas 1994. The UL transmitter 1984 may include a PUCCH transmitter 1990 and a PUSCH transmitter 1992. The DL receiver 1982 may include a PDCCH receiver 1986 and a PDSCH receiver 1988. The higher layer processor 1980 may manage physical layer's behaviors (the UL transmitter's and the DL receiver's behaviors) and provide higher layer parameters to the physical layer. The higher layer processor 1980 may obtain transport blocks from the physical layer. The higher layer processor 1980 may send/acquire higher layer messages such as an RRC message and MAC message to/from a UE's higher layer. The higher layer processor 1980 may provide the PUSCH transmitter transport blocks and provide the PUCCH transmitter UCI. The DL receiver may receive multiplexed downlink physical channels and downlink physical signals via receiving antennas and de-multiplex them. The PDCCH receiver 1986 may provide the higher layer processor DCI. The PDSCH receiver 1988 may provide the higher layer processor 1980 received transport blocks.

The UE 102 may include a higher layer processor configured to transfer a dedicated radio resource control (RRC) configuration message as part of UE capability information. The dedicated RRC configuration message may include information indicating a minimum required window size for look-ahead (LA) processing. The UE 102 may include a higher layer processor configured to transfer a dedicated RRC configuration message. The dedicated RRC configuration message may include information indicating an uplink (UL) quality report. The UE 102 may include a higher layer processor configured to acquire a dedicated RRC configuration message. The dedicated RRC configuration message may include information indicating an LA enable signal, an LA window, and an UL quality threshold. The UE 102 may include physical downlink control channel (PDCCH) receiving circuitry configured to monitor a PDCCH. The PDCCH may carry a downlink control information (DCI) format that schedules a physical uplink shared channel (PUSCH). The UE 102 may include PUSCH transmitting circuitry configured to transmit the PUSCH in a first cell group upon detection of the PDCCH. In a case the PUSCH is transmitted within the LA window, a first transmit power of the PUSCH may be derived using a second transmit power of a physical uplink channel of a second cell group. In a case the PUSCH is transmitted outside the LA window, the first transmit power of the PUSCH may be derived without using the second transmit power of the physical uplink channel of the second cell group. A transmission of the physical uplink channel may start after a transmission of the PUSCH starts.

The gNB 160 may include a higher layer processor configured to transmit a dedicated radio resource control (RRC) configuration message. The dedicated RRC configuration message may include information indicating a look-ahead (LA) enable signal, an LA window, and an uplink (UL) quality threshold. The gNB 160 may include physical downlink control channel (PDCCH) transmitting circuitry configured to transmit a PDCCH. The PDCCH may carry a downlink control information (DCI) format that schedules a physical uplink shared channel (PUSCH). The gNB 160 may include PUSCH receiving circuitry configured to receive the PUSCH in a first cell group upon detection of the PDCCH. In a case the PUSCH is transmitted within the LA window, a first transmit power of the PUSCH may be derived using a second transmit power of a physical uplink channel of a second cell group. In a case the PUSCH is transmitted outside the LA window, the first transmit power of the PUSCH may be derived without using the second transmit power of the physical uplink channel of the second cell group. A transmission of the physical uplink channel may start after a transmission of the PUSCH starts.

It should be noted that various modifications are possible within the scope of the present invention defined by claims, and embodiments that are made by suitably combining technical means disclosed according to the different embodiments are also included in the technical scope of the present invention.

It should be noted that names of physical channels described herein are examples. The other names such as “NRPDCCH, NRPDSCH, NRPUCCH and NRPUSCH”, “new Generation-(G)PDCCH, GPDSCH, GPUCCH and GPUSCH” or the like can be used.

The term “computer-readable medium” refers to any available medium that can be accessed by a computer or a processor. The term “computer-readable medium,” as used herein, may denote a computer- and/or processor-readable medium that is non-transitory and tangible. By way of example, and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods, and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD, and the like), a magnetic storage medium (for example, a magnetic tape, a flexible disk, and the like), and the like, any one may be possible. Furthermore, in some cases, the function according to the described systems and methods described above is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described above may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

What is claimed is:

1. A user equipment (UE) comprising:
a higher layer processor configured to transfer a dedicated radio resource control (RRC) configuration message as part of UE capability information, the dedicated RRC configuration message comprising information indicating a minimum required window size for look-ahead (LA) processing;
a higher layer processor configured to transfer a dedicated RRC configuration message, the dedicated RRC configuration message comprising information indicating an uplink (UL) quality report;
a higher layer processor configured to acquire a dedicated RRC configuration message, the dedicated RRC configuration message comprising information indicating an LA enable signal, an LA window, and an UL quality threshold;
physical downlink control channel (PDCCH) receiving circuitry configured to monitor a PDCCH, wherein the PDCCH carries a downlink control information (DCI) format that schedules a physical uplink shared channel (PUSCH); and
PUSCH transmitting circuitry configured to transmit the PUSCH in a first cell group upon detection of the PDCCH, wherein
in a case the PUSCH is transmitted within the LA window, a first transmit power of the PUSCH is derived using a second transmit power of a physical uplink channel of a second cell group,
in a case the PUSCH is transmitted outside the LA window, the first transmit power of the PUSCH is derived without using the second transmit power of the physical uplink channel of the second cell group, and
a transmission of the physical uplink channel starts after a transmission of the PUSCH starts.

2. A base station apparatus comprising:
a higher layer processor configured to transmit a dedicated radio resource control (RRC) configuration message, the dedicated RRC configuration message comprising information indicating a look-ahead (LA) enable signal, an LA window, and an uplink (UL) quality threshold;
physical downlink control channel (PDCCH) transmitting circuitry configured to transmit a PDCCH, wherein the PDCCH carries a downlink control information (DCI) format that schedules a physical uplink shared channel (PUSCH); and
PUSCH receiving circuitry configured to receive the PUSCH in a first cell group upon detection of the PDCCH, wherein
in a case the PUSCH is transmitted within the LA window, a first transmit power of the PUSCH is derived using a second transmit power of a physical uplink channel of a second cell group,
in a case the PUSCH is transmitted outside the LA window, the first transmit power of the PUSCH is derived without using the second transmit power of the physical uplink channel of the second cell group, and
a transmission of the physical uplink channel starts after a transmission of the PUSCH starts.

3. A method performed by a user equipment (UE) comprising:
transferring a dedicated radio resource control (RRC) configuration message as part of UE capability information, the dedicated RRC configuration message comprising information indicating a minimum required window size for look-ahead (LA) processing;
transferring a dedicated RRC configuration message, the dedicated RRC configuration message comprising information indicating an uplink (UL) quality report;
acquiring a dedicated RRC configuration message, the dedicated RRC configuration message comprising information indicating an LA enable signal, an LA window, and an UL quality threshold;
monitoring a PDCCH, wherein the PDCCH carries a downlink control information (DCI) format that schedules a physical uplink shared channel (PUSCH); and
transmitting the PUSCH in a first cell group upon detection of the PDCCH, wherein
in a case the PUSCH is transmitted within the LA window, a first transmit power of the PUSCH is derived using a second transmit power of a physical uplink channel of a second cell group,
in a case the PUSCH is transmitted outside the LA window, the first transmit power of the PUSCH is derived without using the second transmit power of the physical uplink channel of the second cell group, and
a transmission of the physical uplink channel starts after a transmission of the PUSCH starts.

4. A method performed by a base station apparatus, comprising:
transmitting a dedicated radio resource control (RRC) configuration message, the dedicated RRC configuration message comprising information indicating a look-ahead (LA) enable signal, an LA window, and an uplink (UL) quality threshold;
transmitting a PDCCH, wherein the PDCCH carries a downlink control information (DCI) format that schedules a physical uplink shared channel (PUSCH); and
receiving the PUSCH in a first cell group upon detection of the PDCCH, wherein
in a case the PUSCH is transmitted within the LA window, a first transmit power of the PUSCH is derived using a second transmit power of a physical uplink channel of a second cell group,
in a case the PUSCH is transmitted outside the LA window, the first transmit power of the PUSCH is derived without using the second transmit power of the physical uplink channel of the second cell group, and
a transmission of the physical uplink channel starts after a transmission of the PUSCH starts.
